(19) United States
(12) Patent Application Publication
(10) Pub. No.: US 2023/0155305 A1
(43) Pub. Date: May 18, 2023

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Daichi KAWAGUCHI, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 17/915,144

(22) PCT Filed: Mar. 23, 2021
(86) PCT No.: PCT/JP2021/011860

§ 371 Date: Sep. 28, 2022

(30) Foreign Application Priority Data
Apr. 15, 2020 (JP) 2020-072898

(51) Int. Cl. H01R 4/02; H01B 7/00; H01B 7/08

(52) U.S. Cl. CPC H01R 4/023; H01B 7/0045; H01B 7/08

(57) ABSTRACT

A wire harness including: a core wire having a parent braided wire obtained by braiding together assembled wires including twisted wires; and a metal terminal welded to the parent braided wire of the core wire, wherein the twisted wires forming the parent braided wire include a first twisted wire twisted in a first rotation direction and a second twisted wire twisted in a second rotation direction opposite to the first rotation direction.

### BACKGROUND

The present disclosure relates to a wire harness.

Conventionally, there are wire harnesses provided in vehicles and the like that have a core wire obtained by further twisting together twisted wires which are each obtained by twisting wire strands (e.g., see JP 2018-37371A). With such a wire harness, the wire strands tend not to unravel and have excellent flexibility and high tensile strength, compared to cases such as where the wire strands are simply provided in parallel, for example.

### SUMMARY

However, with the core wire of the wire harness described above, due to all the wires being twisted in the same direction, there is a risk that, when the core wire is ultrasonically welded to a metal terminal, a force twisting in one direction will act on the metal terminal, for example.

An exemplary aspect of the disclosure provides a wire harness capable of suppressing a twisting force that acts on a metal terminal.

The wire harness of the present disclosure is a wire harness including a core wire having a parent braided wire obtained by braiding together assembled wires including twisted wires, and a metal terminal welded to the parent braided wire of the core wire, the twisted wires forming the parent braided wire including a first twisted wire twisted in a first rotation direction and a second twisted wire twisted in a second rotation direction opposite to the first rotation direction.

According to a wire harness of the present disclosure, it is possible to suppress a twisting force that acts on a metal terminal.

### BRIEF DESCRIPTION OF THE DRAWINGS

FIG. 1 is a plan view of a wire harness in one embodiment.

FIG. 2 is a cross-sectional view taken along 2-2 of FIG. 1 in one embodiment.

FIG. 3 is a cross-sectional view of a parent braided wire in a first separate example.

FIG. 4 is a plan view of a wire harness in a second separate example.

### DETAILED DESCRIPTION OF EMBODIMENTS

### Description of Embodiments of Disclosure

Initially, modes of the present disclosure will be enumerated and described.

A wire harness of the present disclosure is:

[1] A wire harness including a core wire having a parent braided wire obtained by braided together assembled wires including twisted wires, and a metal terminal welded to the parent braided wire of the core wire, the twisted wires constituting the parent braided wire including a first twisted wire twisted in a first rotation direction and a second twisted wire twisted in a second rotation direction opposite to the first rotation direction.

According to this configuration, the core wire has a parent braided wire obtained by braiding together assembled wires including twisted wires, and thus the wire strands tend not to unravel and have excellent flexibility and high tensile strength, compared to cases such as where the wire strands are simply provided in parallel, for example. Also, the twisted wires constituting the parent braided wire include a first twisted wire twisted in a first rotation direction and a second twisted wire twisted in a second rotation direction opposite to the first rotation direction, and thus a force that twists in one direction acting on the metal terminal welded to the parent braided wire is suppressed.

[2] Preferably, the first twisted wire and the second twisted wire are the same in number.

According to this configuration, the number of first twisted wires and the number of second twisted wires are the same, and thus the twisting force acting on the metal terminal welded to the parent braided wire can be equalized in both directions.

[3] Preferably, wire strands constituting the first twisted wire and wire strands constituting the second twisted wire are the same in number.

According to this configuration, the number of wire strands constituting the first twisted wires and the number of wire strands constituting the second twisted wires are the same, and thus the twisting force acting on the metal terminal welded to the parent braided wire can be equalized in both directions.

[4] Preferably, the parent braided wire is obtained by braiding together the assembled wires to be flat.

According to this configuration, the parent braided wire is obtained by braiding together the assembled wires to be flat, and thus the wire harness can be lowered in height.

[5] Preferably, the assembled wires are each formed to be flat.

According to this configuration, the assembled wires are formed to be flat, and thus the wire harness can be further lowered in height.

### Detailed Description of Embodiments of Disclosure

Specific examples of a wire harness of the present disclosure will be described below with reference to the drawings. Note that the present disclosure is not limited to these illustrative examples and is defined by the claims, and all changes that come within the meaning and range of equivalency of the claims are intended to be embraced therein.

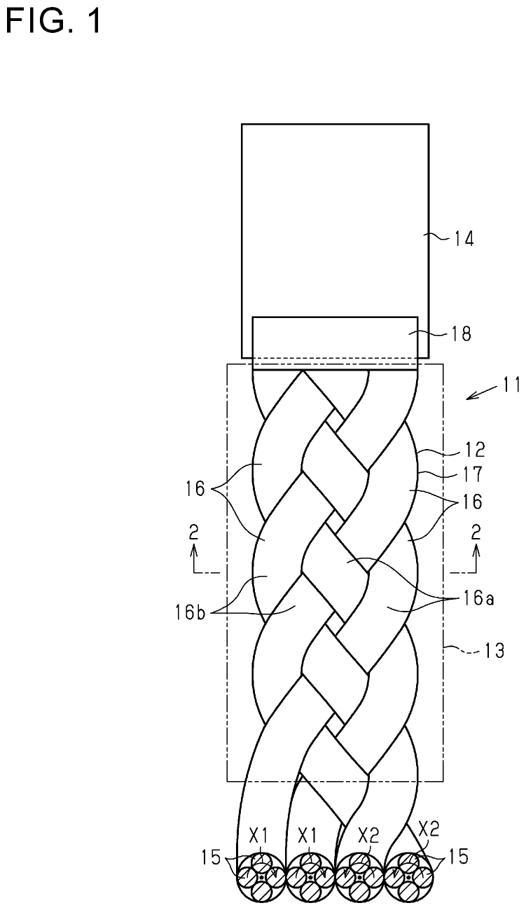

As shown in FIG. 1, a wire harness 11 includes a core wire 12, an insulating exterior material 13 covering the core wire 12, and a metal terminal 14.

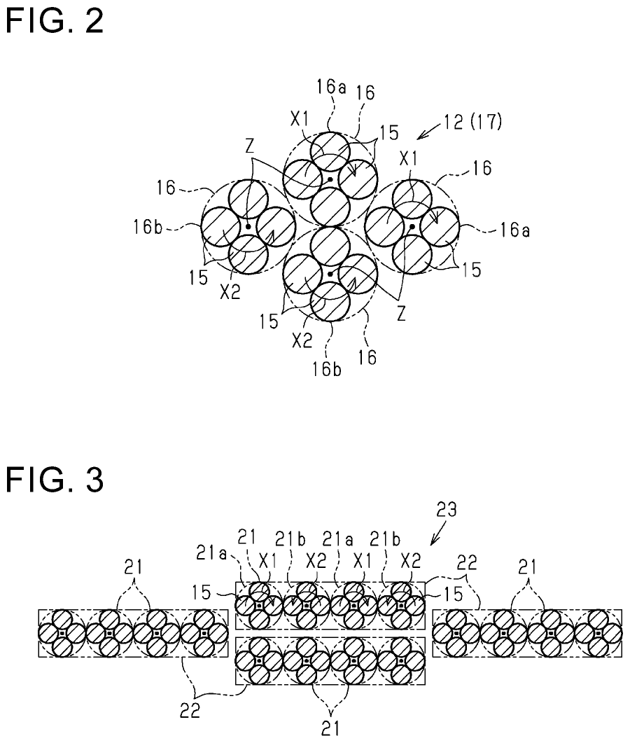

As shown in FIGS. 1 and 2, the core wire 12 is formed from a parent braided wire 17 obtained by braiding together twisted wires 16 serving as assembled wires which are each obtained by twisting wire strands 15. Specifically, the parent braided wire 17 constituting the core wire 12 of the present embodiment is obtained by braiding together four twisted wires 16 in such a manner as to be in a flat state, or in other words, in such a manner that the vertical height is smaller than the width. Note that the vertical direction is a direction corresponding to a direction orthogonal to the surface of the page of FIG. 1, and the width is the length in a direction orthogonal to the extending direction of the core wire 12 as seen vertically.

Also, as shown in FIG. 2, the twisted wires 16 are each obtained by twisting four wire strands 15 in a rotation direction around an axis Z in the extending direction thereof. Note that, in FIG. 1, the boundaries between the wire strands 15 in a single twisted wire 16 are not illustrated, and the core wire 12 is illustrated in such a manner that the boundaries between the twisted wires 16 are easily ascertained visually.

Also, as shown in FIG. 2, the plurality of twisted wires 16 constituting the parent braided wire 17 include first twisted wires 16a twisted in a first rotation direction X1 around the axis Z and second twisted wires 16b twisted in a second rotation direction X2 opposite to the first rotation direction X1. The number of first twisted wires 16a and the number of second twisted wires 16b are the same at two each. In other words, half of the even number of twisted wires 16 are the first twisted wires 16a, and the remaining half are the second twisted wires 16b. Also, as aforementioned, the number of wire strands 15 constituting the first twisted wires 16a and the number of wire strands 15 constituting the second twisted wires 16b are the same at four each.

The insulating exterior material 13 is, for example, obtained by assembling a pair of upper and lower resin molded articles, and covers the core wire 12 while also being provided to sandwich the core wire 12 and holding the braided state of the twisted wires 16 in the core wire 12.

The metal terminal 14 is welded to the parent braided wire 17 of the core wire 12. Specifically, an end portion 18 of the parent braided wire 17 is ultrasonically welded to the metal terminal 14 disposed downward thereof while being pressed downward from above. Note that, given that the end portion 18 of the parent braided wire 17 is ultrasonically welded so as to be flattened vertically, the boundaries between the wire strands 15 in the end portion 18 of the parent braided wire 17 and the boundaries between the twisted wires 16 are not illustrated in FIG. 1.

Next, operation of the wire harness 11 configured as described above will be described.

The core wire 12 of the wire harness 11 has the parent braided wire 17 obtained by braiding together the twisted wires 16, and thus the wire strands 15 tend not to unravel and have excellent flexibility and high tensile strength, compared to cases such as where the wire strands 15 are simply provided in parallel, for example.

Next, effects of the above embodiment will be described hereinafter.

(1) The plurality of twisted wires 16 constituting the parent braided wire 17 include the first twisted wires 16a twisted in the first rotation direction X1 and the second twisted wires 16b twisted in the second rotation direction X2 opposite to the first rotation direction X1, and thus a force that twists in one direction acting on the metal terminal 14 welded to the parent braided wire 17 is suppressed.

(2) The numbers of first twisted wires 16a and second twisted wires 16b constituting the parent braided wire 17 are the same, and thus the twisting force acting on the metal terminal 14 welded to the parent braided wire 17 can be equalized in both directions.

(3) The number of wire strands 15 constituting the first twisted wires 16a and the number of wire strands 15 constituting the second twisted wires 16b are the same, and thus the twisting force acting on the metal terminal 14 welded to the parent braided wire 17 can be equalized in both directions.

(4) The parent braided wire 17 is obtained by braiding together the twisted wires 16 to be flat, and thus the wire harness 11 can be lowered in height.

The present embodiment can be modified and implemented as follows. The present embodiment and the following modification examples can be implemented in combination with each other as long as there are no technological incompatibilities.
In the above embodiment, the parent braided wire 17 is obtained by braiding together the twisted wires 16 serving as the assembled wires, but may be implemented as another parent braided wire obtained by braiding together other assembled wires including twisted wires.

For example, as in a first separate example schematically shown in FIG. 3, a parent braided wire 23 may be obtained by braiding together four assembled wires 22 which are each obtained by providing four twisted wires 21 in parallel, so as to be in a flat state with a similar braiding method to the above embodiment. In this case, for example, the four wire strands 21 in each assembled wire 22 may include first twisted wires 21a twisted in the first rotation direction X1 and second twisted wires 21b twisted in the second rotation direction X2 opposite to the first rotation direction X1. Such a configuration similarly allows a force that twists in one direction acting on the metal terminal welded to the parent braided wire 23 to be suppressed. Also, the assembled wires 22 are formed to be flat, and thus the wire harness can be further lowered in height.

Also, for example, a parent braided wire may be obtained by braiding together a plurality of braided wires serving as the assembled wires which are each obtained by braiding a plurality of twisted wires.

Also, for example, a parent braided wire may be obtained by braiding together a plurality of twisted wires serving as the assembled wires which are each obtained by further twisting a plurality of twisted wires.

Also, for example, a parent braided wire may be obtained by braiding together a plurality of twisted wires serving as the assembled wires which are each obtained by twisting a plurality of braided wires.
In the above embodiment, the parent braided wire 17 is obtained by braiding together the twisted wires 16 in such a manner as to be in a flat state, or in other words, in such a manner that the vertical height is smaller than the width, but is not limited thereto, and may be obtained by braiding twisted wires into a shape other than a flat shape.

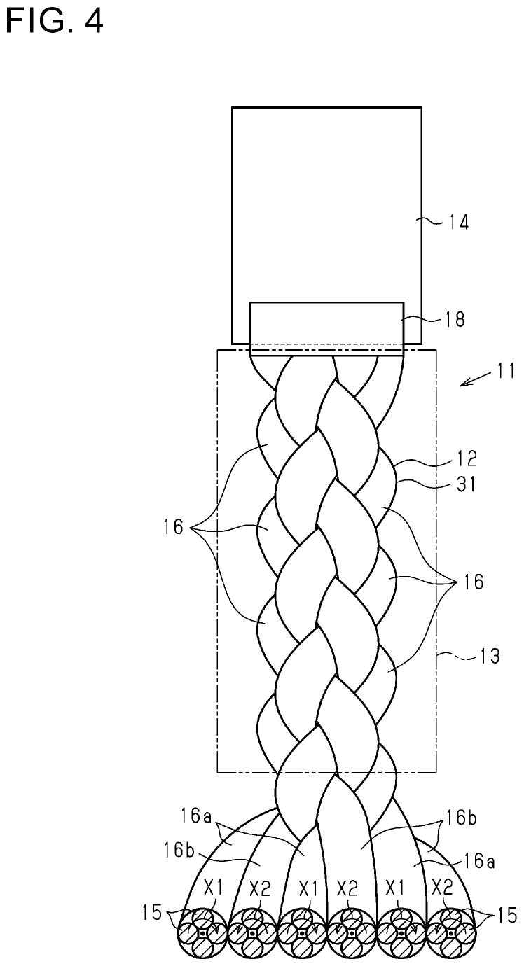

For example, as in a second separate example shown in FIG. 4, a parent braided wire 31 may be obtained by braiding the twisted wires 16, or specifically, the first twisted wires 16a and the second twisted wires 16b, in such a manner as to be in an approximately circular state in cross section, or in other words, in such a manner that the vertical height and the width are substantially the same.
In the above embodiment, the numbers of first twisted wires 16a and second twisted wires 16b constituting the parent braided wire 17 are the same, but are not limited thereto, and the numbers thereof may differ. For example, an odd number of twisted wires 16 may be provided, the number of first twisted wires 16a may be one more or one less than the number of second twisted wires 16b.
In the above embodiment, the number of wire strands 15 constituting the first twisted wires 16a and the number of wire strands 15 constituting the second twisted wires 16b are the same, but are not limited thereto, and, for example, the numbers of some thereof may differ.
In the above embodiment, the parent braided wire 17 is obtained by braiding together four twisted wires 16 serving as the assembled wires, but is not limited thereto, and may, for example, be obtained by braiding together assembled wires of another number such as six or eight.
In the above embodiment, the twisted wires 16 are each obtained by twisting four wire strands 15, but are not limited thereto, and may, for example, be obtained by twisting wire strands 15 of another number such as eight or a dozen or more.
In the above embodiment, the wire harness 11 is provided with the insulating exterior material 13 that is obtained by assembling a pair of upper and lower resin molded articles and covers the core wire 12 while also being provided to sandwich the core wire 12 and holding the braided state of the twisted wires 16 in the core wire 12, but is not limited thereto, and may instead be provided with an insulating member having another configuration that covers the core wire 12.

The present disclosure encompasses the following implementation examples. Reference numerals of the constituent elements of the embodiment are given not for limitation purposes but to facilitate understanding.

[Note 1] A wire harness (11) including:

a parent braided wire (17; 23; 31); and

two metal terminals fixed one to either end of the parent braided wire (17; 23; 31),

wherein the parent braided wire (17; 23; 31) has a plurality of twisted wires braided together, and

the plurality of twisted wires include one or more first twisted wires (16a; 21a) and one or more second twisted wires (16b; 21b),

the first twisted wires (16a; 21a) each include a plurality of wire strands (15) twisted in a first rotation direction (X1), and

the second twisted wires (16b; 21b) each include a plurality of wire strands (15) twisted in a second rotation direction (X2) which is an opposite direction to the first rotation direction (X1).

[Note 2] In one or more implementation examples of the present disclosure, the parent braided wire (17; 23; 31) may be braided in such a manner that at least one of the first twisted wires (16a; 21a) and at least one of the second twisted wires (16b; 21b) contact each other.

[Note 3] In one or more implementation examples of the present disclosure, the parent braided wire (17; 23; 31) may have the first twisted wires (16a; 21a) and the second twisted wires (16b; 21b) alternately arranged side by side in a width direction thereof or a thickness direction thereof.

[Note 4] In one or more implementation examples of the present disclosure, in the parent braided wire (17; 23; 31), the number of twisted wires (16; 21) arranged side by side in the width direction thereof may be greater than the number of twisted wires (16; 21) arranged side by side in the thickness direction thereof.

[Note 5] In one or more implementation examples of the present disclosure, the parent braided wire (23) may include a plurality of assembled wires (22) braided together, and the assembled wires (22) may each include a plurality of the twisted wires (21) arranged side by side in a width direction of the wire harness (11).

[Note 6] In one or more implementation examples of the present disclosure, the assembled wires (22) may each include one or more of the first twisted wires (21a) and one or more of the second twisted wires (21b) arranged side by side in the width direction.

[Note 7] In one or more implementation examples of the present disclosure, the parent braided wire (23) may include three or more of the assembled wires (22) arranged side by side in the width direction of the wire harness (11).

[Note 8] In one or more implementation examples of the present disclosure, the parent braided wire (23) may include a plurality of the assembled wires (22) arranged side by side in a thickness direction of the wire harness (11).

[Note 9] In one or more implementation examples of the present disclosure, the wire harness (11) may include an insulating exterior material (13) covering the parent braided wire (17; 23; 31).

1. A wire harness comprising:
a core wire having a parent braided wire obtained by braiding together assembled wires including twisted wires; and
a metal terminal welded to the parent braided wire of the core wire,
wherein the twisted wires forming the parent braided wire include a first twisted wire twisted in a first rotation direction and a second twisted wire twisted in a second rotation direction opposite to the first rotation direction.

2. The wire harness according to claim 1,
wherein the first twisted wire and the second twisted wire are the same in number.

3. The wire harness according to claim 2,
wherein wire strands forming the first twisted wire and wire strands forming the second twisted wire are the same in number.

4. The wire harness according to claim 1,
wherein the parent braided wire is obtained by braiding together the assembled wires to be flat.

5. The wire harness according to claim 4,
wherein the assembled wires are each formed to be flat.
